(19) United States
(12) Patent Application Publication
(10) Pub. No.: US 2026/0292374 A1
(43) Pub. Date: Sep. 24, 2026

(54) TRANSMISSION DATA PROCESSING METHOD AND OPTICAL FIBER NETWORK SYSTEM

(71) Applicant: REALTEK SINGAPORE PRIVATE LIMITED, SINGAPORE (SG)

(72) Inventor: Donggun Keung, Milpitas, CA (US)

(21) Appl. No.: 19/087,677

(22) Filed: Mar. 24, 2025

(51) Int. Cl. H04Q 11/00; H04B 10/25

(52) U.S. Cl. CPC H04Q 11/0062; H04B 10/25; H04Q 2011/0079

(57) ABSTRACT

A transmission data processing method is performed by an optical fiber network system and includes processes of: negotiating a compression algorithm between an optical line terminal (OLT) and a plurality of optical network units (ONUs); and transmitting data that is compressed by using the negotiated compression algorithm between the OLT and the ONUs.

### FIELD OF THE DISCLOSURE

The present disclosure relates to an optical fiber network data processing method, and more particularly to a transmission data processing method and an optical fiber network system that have a compression mechanism.

### BACKGROUND OF THE DISCLOSURE

How to improve effective data throughput between an optical line terminal (OLT) and a plurality of optical network units(ONUs) in a gigabit passive optical network (PON) system has become a widely discussed topic.

As published in prior art U.S. Pat. No. 10,880,410B2, in order to increase an amount of data that is allowed to be transmitted through network, the data is compressed and then the compressed data is transmitted through the network. However, new ONU management and control interface (OMCI) messages must be exchanged between the OLT and the ONUs for setting a compression table. The OMCI message complying with an ITU-T G.988 standard is a control message stored at a high management level (usually belonging to a management and control layer). Therefore, in an existing GPON system, software (SW) of the OLT and ONUs need to be upgraded, and the OMCI message must be transmitted through one-to-one bidirectional communication on a management channel between the OLT and the ONUs. However, a PON architecture is one(OLT)-to-multiple(ONUs) communication architecture. That is, the prior art still has some shortcomings.

It is necessary to develop how to realize compression negotiation on the management channel between the OLT and the ONUs in the one (OLT)-to-multiple(ONUs) communication architecture (in a broadcast manner), under existing standards such as ITU-T G.988, G.984, G.989.3, G.987 and a PON physical layer protocol.

### SUMMARY OF THE DISCLOSURE

In response to the above-referenced technical inadequacies, the present disclosure provides a transmission data processing method. The transmission data processing method is applied to an optical fiber network system including an optical line terminal (OLT) and a plurality of optical network units (ONUs). The transmission data processing method including processes of: generating, by the optical line terminal, a first compression negotiation code according to a compression algorithm supported by the optical line terminal; broadcasting, by the optical line terminal, a first compression negotiation signal including the first compression negotiation code respectively to the plurality of optical network units; generating, by at least one of the plurality of optical network units, a second compression negotiation code according to a compression algorithm supported by the at least one of the plurality of optical network units; transmitting, by the at least one of the plurality of optical network units, a second compression negotiation signal including the second compression negotiation code to the optical line terminal; compressing, by the at least one of the plurality of optical network units, a network unit data into a network unit transmitted data by using the compression algorithm supported by the at least one of the plurality of optical network units; outputting the network unit transmitted data to the optical line terminal by the at least one of the plurality of optical network units; and decompressing the network unit transmitted data by the optical line terminal. The first compression negotiation signal and the second compression negotiation signal comply with a physical layer protocol standard of the optical fiber network system.

In order to solve the above-mentioned problems, one of the technical aspects adopted by the present disclosure is to provide an optical fiber network system. The optical fiber network system includes an optical line terminal and a plurality of optical network units. The optical line terminal is configured to generate a first compression negotiation code according to a compression algorithm supported by the optical line terminal. The optical line terminal is configured to broadcast a first compression negotiation signal including the first compression negotiation code. At least one of the plurality of optical network units is configured to generate a second compression negotiation code, according to a compression algorithm supported by the at least one of the plurality of optical network units. The at least one of the plurality of optical network units is configured to transmit a second compression negotiation signal including the second compression negotiation code to the optical line terminal. The first compression negotiation signal and the second compression negotiation signal comply with a physical layer protocol standard of the optical fiber network system. The at least one of the plurality of optical network units is configured to compress the network unit data into a network unit transmitted data by using the compression algorithm supported by the at least one of the plurality of optical network units. The at least one of the plurality of optical network units is configured to output the network unit transmitted data to the optical line terminal. The optical line terminal is configured to decompress the network unit transmitted data.

As described above, the present disclosure provides the transmission data processing method and the optical fiber network system. The compression algorithms are negotiated between transmitted between the optical line terminal (OLT) and the plurality of optical network units (ONUs). After the compression algorithms are negotiated between the OLT and the plurality of ONUs, the data that is compressed by using the negotiated compression algorithm is transmitted bidirectionally or unidirectionally between the OLT and at least one of the plurality of ONUs. Therefore, data throughput between the OLT and the ONUs is effectively improved, and data traffic per unit time between the OLT and the ONUs is increased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart diagram of an optical fiber network data processing method according to an embodiment of the present disclosure;

FIG. 2 is a block diagram of an optical network unit (ONU) performing compression in an optical fiber network data processing method and an optical fiber network system according to an embodiment of the present disclosure;

FIG. 3 is a block diagram of an optical line terminal (OLT) performing decompression in an optical fiber network data processing method and an optical fiber network system according to an embodiment of the present disclosure;

FIG. 4 is a block diagram of an optical line terminal (OLT) performing compression in an optical fiber network data processing method and an optical fiber network system according to an embodiment of the present disclosure;

FIG. 5 is a block diagram of an optical network unit (ONU) performing decompression in an optical fiber network data processing method and an optical fiber network system according to an embodiment of the present disclosure;

FIG. 6 is a schematic diagram of instruction fields used to be filled with a compressed message or an uncompressed message of an optical fiber network data processing method and an optical fiber network system according to an embodiment of the present disclosure; and

FIG. 7 is a flowchart diagram of an optical fiber network data processing method determining whether to perform compression in an optical fiber network system according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In the transmission data processing method of the present disclosure, the optical fiber network system of the present disclosure performs data compression negotiation under a low layer protocol (such as a physical layer protocol) of a passive optical network(PON) standard.

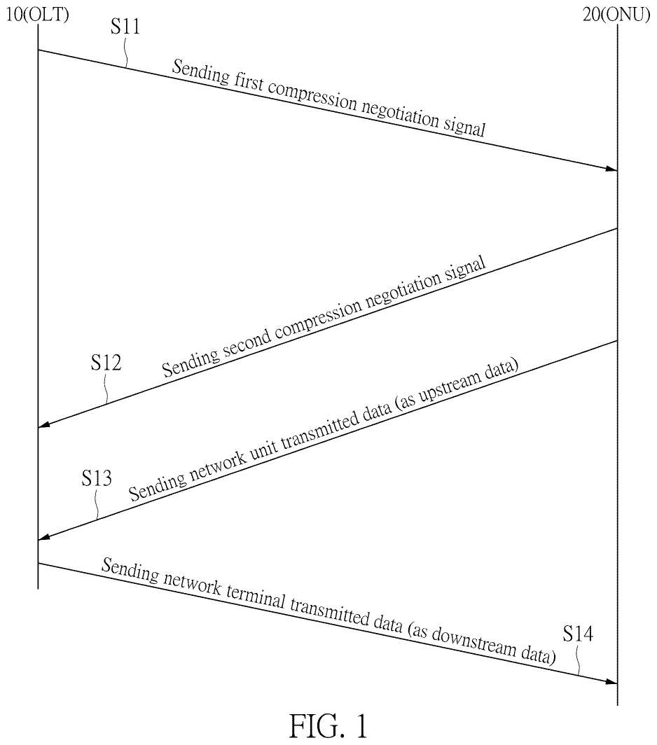

Reference is made to FIG. 1, which is a flowchart diagram of an optical fiber network data processing method according to an embodiment of the present disclosure.

The transmission data processing method of the present disclosure includes processes S11 to S14 shown in FIG. 1. As shown in FIG. 1, the transmission data processing method of the present disclosure is applied to the optical fiber network system of the present disclosure. The optical fiber network system includes an optical line terminal 10 (OLT) and a plurality of optical network units(ONUs) 20.

The optical line terminal 10 generates a first compression negotiation code according to a compression algorithm supported by the optical line terminal 10. he optical line terminal 10 broadcasts a first compression negotiation signal including the first compression negotiation code to the optical network unit 20 (in process S11 of FIG. 1). The plurality of optical network units 20 learn the compression algorithm supported by the optical line terminal 10 according to the first compression negotiation signal.

On the other hand, the optical network unit 20 generates a second compression negotiation code according to a compression algorithm supported by the optical network unit 20. The optical network unit 20 transmits a second compression negotiation signal including the second compression negotiation code to the optical line terminal 10 (in process S12 of FIG. 1). The optical line terminal 10 learns the compression algorithm supported by the optical network unit 20 according to the second compression negotiation signal. The OLT stores the compression algorithm selected by each of the plurality of ONUs. The OLT may use different compression algorithm for each of the plurality of ONUs.

In one example, the optical line terminal 10 and the optical network unit 20 support a plurality of compression algorithms that are respectively represented by a plurality of compression negotiation codes such as three compression negotiation codes “01”, “10” and “11”, and “00” represents the uncompressed message, but the present disclosure is not limited thereto. If the optical line terminal 10 supports the plurality of compression algorithms, the optical line terminal 10 selects all or some of the plurality of compression algorithms that are supported by itself, and broadcasts the first compression negotiation signal including the first compression negotiation codes that respectively represent the compression algorithms selected by itself to each of the plurality of optical network units 20. Similarly, if the optical network unit 20 supports the plurality of compression algorithms, the optical network unit 20 transmits the second compression negotiation signal including the second compression negotiation codes that respectively represent the compression algorithms selected by itself to the optical line terminal 10. In the one example, the first compression negotiation signal may be a physical layer operation administration and maintenance(PLOAM) message, and the second compression negotiation signal may be an ACK_PLOAM message.

In another example, For example, preset compression capabilities of the OLT 10 and at least one of the plurality of ONUs 20 are negotiated through the PLOAM message transmitted between the OLT 10 and the at least one of the plurality of ONUs 20, and the PLOAM message includes reserved text segments in a BURST_PROFILE set and an ASSIGN_ALLOC_ID_ACK message. In an example, the first compression negotiation code has two ones of offset 38 bits of the BURST_PROFILE message, and the second compression negotiation code has two ones of offset 8 bits of the ASSIGN_ALLOC_ID_ACK message for indication of different lossless data compression techniques. For example, the first or second compression code “00” represents the uncompressed message, “01” represents a Lempel-Ziv-Welch (LZW) algorithm, “10” represents a Deflate algorithm, and “11” represents a Run-Length Encoding (RLE) algorithm.

The OLT stores the compression algorithm selected by each of the plurality of ONUs. The OLT may use different compression algorithm for each of the plurality of ONUs.

After compression negotiation is performed between the optical line terminal 10 and the optical network unit 20 (in processes S11 and S12 of FIG. 1), the network unit 20 learns the compression algorithm supported by the optical line terminal 10. The optical network unit 20 adds a unit compression message code (such as, but not limited to “1”) representing a compressed message to a header of a XG-PON encapsulation (XGEN) frame. Then, the optical network unit 20, by using the compression algorithm supported by the optical network unit 2, compresses a network unit data with the XG-PON encapsulation method (XGEM) frame to output a network unit transmitted data. Then, the optical network unit 20 sends the network unit transmitted data as an upstream data to the optical line terminal 10 (in process S13 of FIG. 1). When the optical line terminal 10 receives the network unit transmitted data including the unit compression message code representing the compressed message from the optical network unit 20, the optical line terminal 10 decompresses the network unit transmitted data into the network unit data by using a decompression algorithm corresponding to the unit compression message code representing the compressed message.

After the compression negotiation is performed between the optical line terminal 10 and the optical network unit 20 (in processes S11 and S12 of FIG. 1), the optical line terminal 10 compresses a network terminal data with a terminal compression message code representing the compressed message (such as, but not limited to “1”) to output a network terminal transmitted data, by using the compression algorithm represented by the first compression negotiation code included in the first compression negotiation signal. The optical line terminal 10 sends the network terminal transmitted data as a downstream data to the optical network unit 20 (in process S14 of FIG. 1).

Then, when the optical network unit 20 receives the network terminal transmitted data including the terminal compression message code representing the compressed message from the optical line terminal 10, the optical network unit 20 decompresses the network terminal transmitted data into the network terminal data, by using a decompression algorithm corresponding to the compression algorithm represented by the first compression negotiation code. The optical network unit 20 stores the network terminal data.

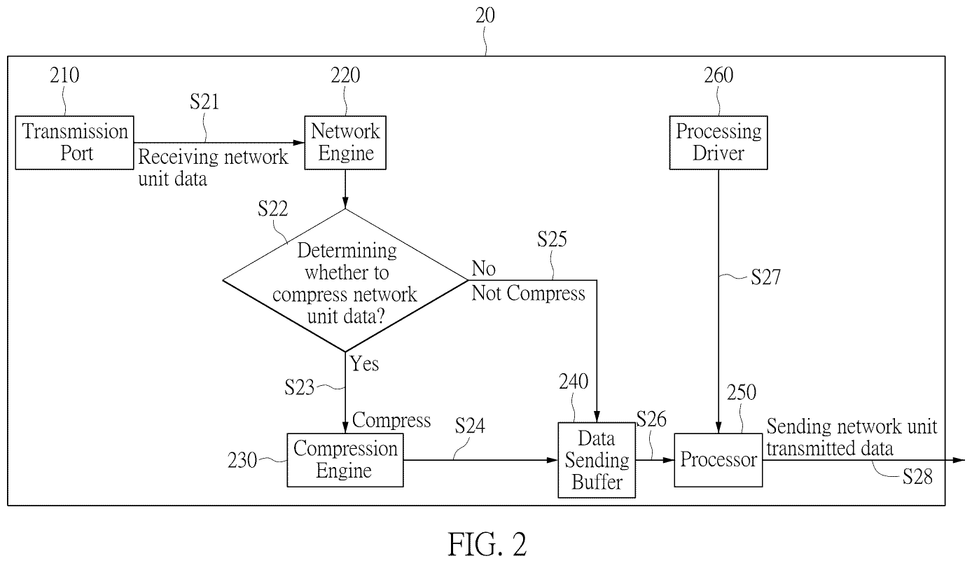

Reference is made to FIG. 2, which is a block diagram of an optical network unit (ONU) of the present disclosure performing compression.

As shown in FIG. 2, the optical network unit 20 includes a transmission port 210, a network engine 220, a compression engine 230, a data sending buffer 240, a processor 250 and a processing driver 260.

The transmission port 210 of the optical network unit 20 transmits the network unit data from the optical line terminal 10 to the network engine 220 (in process S21 of FIG. 2). The network engine 220 determines whether to compress the network unit data and accordingly determines whether to output the network unit data to the compression engine 230 (in process S22 of FIG. 2).

When the network engine 220 determines to compress the network unit data, the network engine 220 outputs the network unit data to the compression engine 230. Then, the compression engine 230 compresses the network unit data into the network unit transmitted data (in process S23 of FIG. 2), and the outputs the network unit transmitted data to the data sending buffer 240 (in process S24 of FIG. 2).

Conversely, when the network engine 220 determines not to compress the network unit data, the network engine 220 directly transmits the network engine 220 from the transmission port 210 to the data sending buffer 240 (in process S25 of FIG. 2).

When the network unit transmitted data is allowed to be uploaded, the processing driver 260 (in process S27 of FIG. 2) drives the data transmission buffer 240 to output the network unit transmitted data (in process S26) cached in the data transmission buffer 240 to the optical line terminal 10 (in process S28 of FIG. 2).

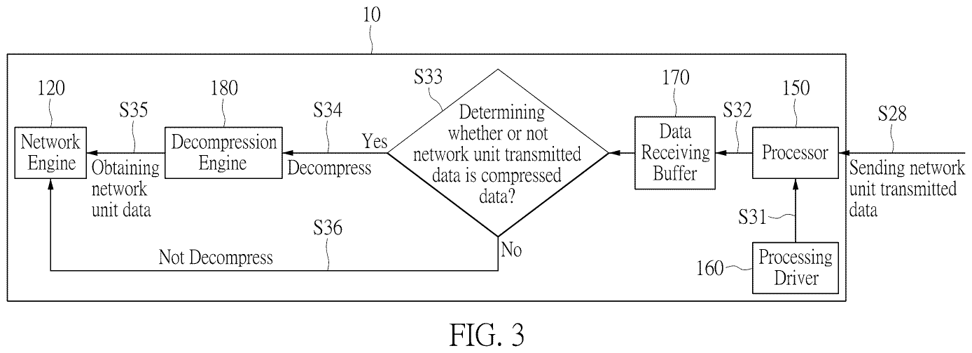

Corresponding to FIG. 2, FIG. 3 is the block diagram of an optical line terminal (OLT) performing decompression in an optical fiber network data processing method and an optical fiber network system according to an embodiment of the present disclosure. The optical line terminal 10 shown in FIG. 3 has a compression mechanism being similar to that of the optical network unit 20 shown in FIG. 2.

As shown in FIG. 3, the optical line terminal 10 includes a network engine 120, a decompression engine 180, a data receiving buffer 170, a processor 150 and a processing driver 160.

The processing driver 160 shown in FIG. 2 drives the processor 150 to receive the network unit transmitted data from the optical network unit 20 (in process S31 of FIG. 3), and transmits the network unit transmitted data to the data receiving buffer 170 (in process S32 of FIG. 3). The data receiving buffer 170 caches the network unit transmitted data.

In the optical line terminal 10, the processor 150 determines whether or not the network unit transmitted data is a compressed data (in process S33 of FIG. 3), and determines the compression algorithm used for compression of the network unit transmitted data, according to the unit compression message code included in the network unit transmitted data.

When the network unit transmitted data is the compressed data, the data receiving buffer 170 transmits the network unit transmitted data to the decompression engine 180 (in process S34 of FIG. 3). Then, the decompression engine 180 decompresses the network unit transmitted data into the network unit data by using the decompression algorithm corresponding to the unit compression message code representing the compressed message, and then outputs the network unit data to the network engine 120 (in process S35 of FIG. 3). Conversely, when the network unit transmitted data is not the compressed data, the data receiving buffer 170 directly transmits the network unit transmitted data to the network engine 120, and then the network engine 120 stores the network unit transmitted data (in process S36 of FIG. 3).

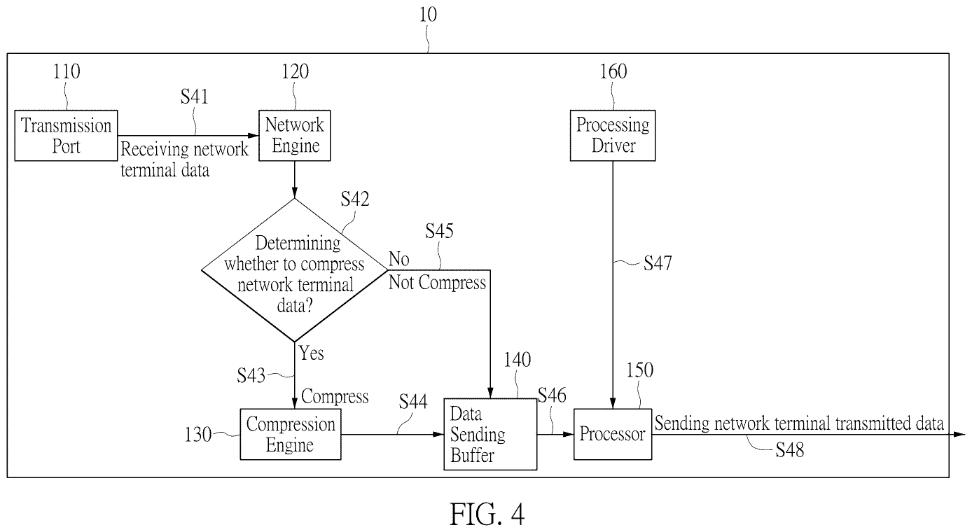

Reference is made to FIG. 4, which is a block diagram of the optical line terminal (OLT) of the present disclosure that is performing compression. The optical line terminal (OLT) shown in FIG. 4 has a compression mechanism being similar to that of the optical network unit (ONU) 20 shown in FIG. 2.

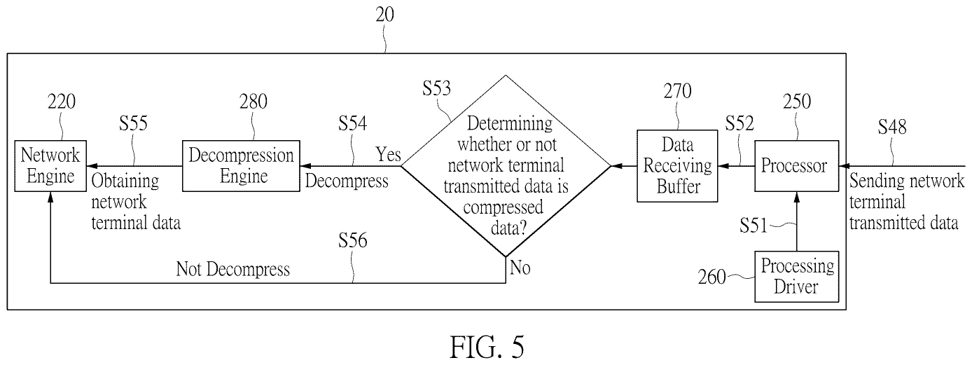

Reference is made to FIG. 5, which is a block diagram of an optical network unit (ONU) performing decompression in an optical fiber network data processing method and an optical fiber network system according to an embodiment of the present disclosure.

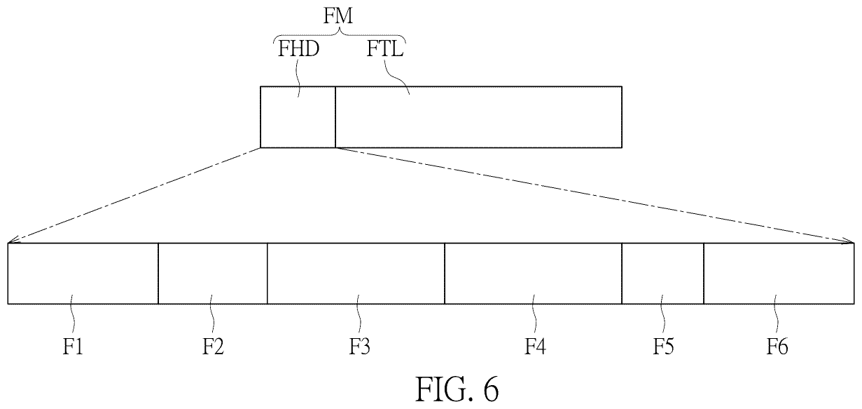

Reference is made to FIG. 6, which is a schematic diagram of instruction fields used to be filled with a compressed message or an uncompressed message of an optical fiber network data processing method and an optical fiber network system according to an embodiment of the present disclosure.

As shown in FIG. 6, an optical fiber network data frame FM includes a plurality of unit negotiation frame portions such as a frame header FHD and a frame trailer FTL. The frame header FHD includes a plurality of sub-frame header portions F1 to F6. The optical network unit 20 shown in FIG. 1 or the network engine 220 of the optical network unit 20 shown in FIG. 2 may add the second compression negotiation code to one of the plurality of unit negotiation frame portions such as one of the plurality of sub-frame header portions F1 to F6 of the frame header FHD.

In an example, the compressed message indicating that the network unit transmitted data is the compressed data, or the uncompressed message indicating that the network unit transmitted data is the uncompressed data, is filled in an Options field of the frame header FHD of the XGEM frame without affecting the GPON system. When the optical network unit 20 stops compressing the network unit data, the GPON system still operates under a ITU standard.

In compression negotiation processes S11 and S12, the first and second compression negotiation codes are included in the reserved text segment defined in accordance with the related standard of the PON. Therefore, when the transmission data processing method and the optical fiber network system of the embodiment of the present disclosure are used in a conventional device, the conventional device stills operate normally without being affected.

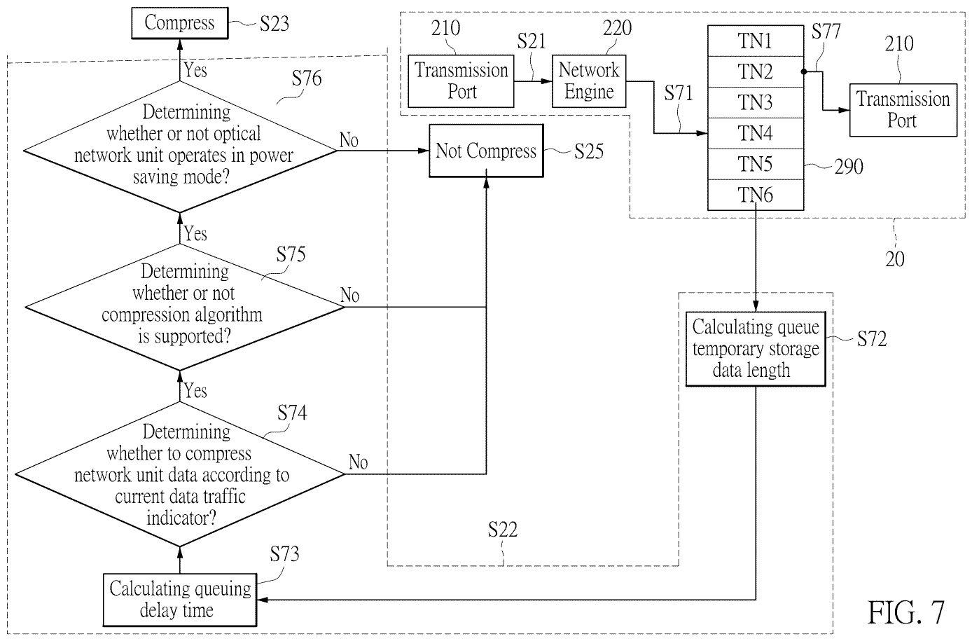

Reference is made to FIG. 7, which is a flowchart diagram of an optical fiber network data processing method determining whether to perform compression in an optical fiber network system according to an embodiment of the present disclosure.

Processes S72 to S76 shown in FIG. 7 may be included in process S22 shown in FIG. 2. In this embodiment of the present disclosure, the network engine 220 determines whether to compress the network unit data based on a current operation mode of the optical network unit 20 and/or a current data traffic congestion situation.

Processes S71 to S77 shown in FIG. 7 may be performed by the optical network unit 20 shown in FIG. 7 or, in practice, performed by the optical line terminal 10 shown in FIG. 4 in the optical fiber network system.

As shown in FIG. 7, the data sending buffer 240 may further include a transmission container 290. The transmission container 290 may include a plurality of sub-transmission containers TN1 to TN6. The plurality of sub-transmission containers TN1 to TN6 are respectively configured to temporarily store a plurality of network unit data and a plurality of network unit transmitted data.

After process S21 shown in FIG. 2 and FIG. 7 is performed, the plurality of network unit data is transmitted to some of the plurality of sub-transmission containers TN1 to TN6 of the transmission container 29 (in process S71 of FIG. 7), and are temporarily stored in the some of the plurality of sub-transmission containers TN1 to TN6.

The network engine 220 determines the current data traffic congestion situation according to a queue temporary storage data length and/or a queuing delay time of the transmission container 290. In an example, the network engine 220 learns a data length (in process S72 of FIG. 7) and/or the queuing delay time (in process S73 of FIG. 7) of each of the plurality of sub-transmission containers TN1 to TN6 of the transmission container 290.

In an example, the network engine 220 determines whether to compress the network unit data according to a current data traffic indicator (in process S73 of FIG. 7). The current data traffic indicator includes the queue temporary storage data length and/or the queuing delay time. For example, the network engine 220 determines whether or not the queue temporary storage data length of the transmission container 290 is larger than a data length threshold or the queuing delay time of the transmission container 290 is larger than a queuing delay threshold.

For example, the network engine 220 looks for the data length threshold and the queuing delay threshold on a lookup table.

If the network engine 220 determines that the queue temporary storage data length of the transmission container 290 is not larger than the data length threshold and the queuing delay time of the transmission container 290 is not larger than the queuing delay threshold, the network engine 220 determines not to compress the network unit data (in process S25 of FIG. 2 and FIG. 7). Under this condition, the network engine 220 directly transmits the network unit data to the data sending buffer 240.

Conversely, if the network engine 220 determines that the queue temporary storage data length of the transmission container 290 is larger than the data length threshold or the queuing delay time of the transmission container 290 is larger than the queuing delay threshold, the network engine 220 determines to compress the network unit data. Under this condition, the network engine 220 transmits the network unit data to the compression engine 230, and then the compression engine 230 compresses the network unit data (in process S23 of FIG. 2 and FIG. 7).

In one example, the compression engine 230 additionally determines whether the compression algorithm is supported by itself (in process S75 of FIG. 3). In another example, the compression engine 230 determines whether or not the current operation mode in which the optical network unit 20 operates is a power saving mode (in process S76 of FIG. 7), and accordingly determines whether to compress the network unit data. In the power saving mode, the network unit data is not compressed.

If the compression engine 230 shown in FIG. 2 determines that the current operation mode in which the optical network unit 20 operates is a normal mode (that is not the power saving mode), the compression engine 230 compresses the network unit data into the network unit transmitted data (in process S23 of FIG. 7), and then outputs the network unit transmitted data to the data sending buffer 240 (in process S24 of FIG. 7). Then, the processing driver 260 shown in FIG. 2 may drive the processor 250 to transmit the network unit transmitted data from the data sending buffer 240 to the transmission container 290 shown in FIG. 7, and the transmission container 290 temporarily stores the transmission container 290. Then, the transmission container 290 may set a time point at which the network unit transmitted data is transmitted to the optical line terminal 10 as a set transmission time point, and outputs the network unit transmitted data through the transmission port 210 to the processor 150 of the optical line terminal 10 shown in FIG. 4 at the set transmission time point (in process S77 of FIG. 7).

That is, the network engine 220 of the optical network unit 20 determines that the data traffic congestion occurs in the optical network unit 20 or the optical network unit 20 does not operate in the power saving mode, the network engine 220 stops the compression engine 230 to compress the network unit data. The processor 250 of the optical network unit 20 sends the optical fiber network data frame FM that includes the plurality of unit negotiation frame portions (including the frame header FHD and the frame trailer FTL as shown in FIG. 6) in which the compressed message or the uncompressed message is filled. Therefore, regardless of whether the optical network unit 20 compresses or stops compressing the network unit data, traffic is not interrupted.

In conclusion, the present disclosure provides the transmission data processing method and the optical fiber network system. The compression algorithms are negotiated between transmitted between the optical line terminal (OLT) and the plurality of optical network units (ONUs). After the compression algorithms are negotiated between the OLT and the plurality of ONUs, the data that is compressed by using the negotiated compression algorithm is transmitted bidirectionally or unidirectionally between the OLT and at least one of the plurality of ONUs. Therefore, data throughput between the OLT and the ONUs is effectively improved, and data traffic per unit time between the OLT and the ONUs is increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transmission data processing method, which is applied to an optical fiber network system including an optical line terminal (OLT) and a plurality of optical network units (ONUs), the transmission data processing method comprising processes of:
generating, by the optical line terminal, a first compression negotiation code according to a compression algorithm supported by the optical line terminal;
broadcasting, by the optical line terminal, a first compression negotiation signal including the first compression negotiation code respectively to the plurality of optical network units;
generating, by at least one of the plurality of optical network units, a second compression negotiation code according to a compression algorithm supported by the at least one of the plurality of optical network units;
transmitting, by the at least one of the plurality of optical network units, a second compression negotiation signal including the second compression negotiation code to the optical line terminal;
transmitting, by the at least one of the plurality of optical network units, a network unit transmitted data to the optical line terminal; and
wherein the first compression negotiation signal and the second compression negotiation signal comply with a physical layer protocol standard of the optical fiber network system.

2. The transmission data processing method according to claim 1, further comprising:
compressing, by the at least one of the plurality of optical network units, a network unit data into the network unit transmitted data by using the compression algorithm supported by the at least one of the plurality of optical network units; and
decompressing, by the optical line terminal, the network unit transmitted data.

3. The transmission data processing method according to claim 1, wherein the first compression negotiation signal and the second compression negotiation signal are physical layer operation administration and maintenance (PLOAM) messages.

4. The transmission data processing method according to claim 3, wherein the first compression negotiation signal is a BURST_PROFILE signal, and the second compression negotiation signal is an ASSIGN_ALLOC_ID_ACK signal.

5. The transmission data processing method according to claim 3, wherein the first compression negotiation code and the second compression negotiation code are included in a reserved text segment defined in accordance with the physical layer protocol standard.

6. The transmission data processing method according to claim 1, further comprising a process of:
determining whether to compress the network unit data according to a current data traffic indicator that includes a queue temporary storage data length, a queuing delay time or a combination thereof.

7. The transmission data processing method according to claim 6, wherein response to determine to compress the network unit data, compressing, by the at least one of the optical network units, the network unit data with a unit compression message code representing a compressed message to transmit the network unit transmitted data.

8. The transmission data processing method according to claim 6, wherein response to determine not to compress the network unit data, transmitting, by the at least one of the plurality of optical network units, the network unit transmitted data according to the network unit data and the unit compression message code representing an uncompressed message.

9. The transmission data processing method according to claim 2, wherein, when the optical fiber network system operates in a power saving mode, not compressing the network unit data.

10. An optical fiber network system, comprising:
an optical line terminal, wherein the optical line terminal is configured to generate a first compression negotiation code according to a compression algorithm supported by the optical line terminal, and to broadcast a first compression negotiation signal including the first compression negotiation code; and
a plurality of optical network units, wherein at least one of the plurality of optical network units is configured to generate a second compression negotiation code according to a compression algorithm supported by the at least one of the plurality of optical network units, and to transmit a second compression negotiation signal including the second compression negotiation code to the optical line terminal;
wherein at least one of the plurality of optical network units is configured to transmit a network unit transmitted data to the optical line terminal;
wherein the first compression negotiation signal and the second compression negotiation signal comply with a physical layer protocol standard of the optical fiber network system.

11. The optical fiber network system according to claim 10, wherein the at least one of the plurality of optical network units compresses the network unit data into the network unit transmitted data by using the compression algorithm supported by the at least one of the plurality of optical network units, and configured to transmit the network unit transmitted data to the optical line terminal; and the optical line terminal decompresses the network unit transmitted data.

12. The optical fiber network system according to claim 10, wherein the first compression negotiation signal and the second compression negotiation signal are PLOAM messages.

13. The optical fiber network system according to claim 12, wherein the first compression negotiation signal is a BURST_PROFILE signal, and the second compression negotiation signal is an ASSIGN_ALLOC_ID_ACK signal.

14. The optical fiber network system according to claim 12, wherein the first compression negotiation code and the second compression negotiation code are included in a reserved text segment defined in accordance with the physical layer protocol standard.

15. The optical fiber network system according to claim 10, wherein the at least one of the optical network units determines whether to compress the network unit data according to a current data traffic indicator, and the current data traffic indicator includes a queue temporary storage data length, a queuing delay time or a combination thereof.

16. The optical fiber network system according to claim 15, wherein response to determine to compress the network unit data, the at least one of the optical network units compresses the network unit data with a unit compression message code representing a compressed message to output the network unit transmitted data.

17. The optical fiber network system according to claim 15, wherein response to determine not to compress the network unit data, the at least one of the optical network units transmits the network unit transmitted data according to the network unit data and the unit compression message code representing an uncompressed message.

18. The optical fiber network system according to claim 10, wherein, when the optical fiber network system operates in a power saving mode, the optical network units do not compress the network unit data.
